(19) United States
(12) Patent Application Publication
(10) Pub. No.: US 2004/0111259 A1
(43) Pub. Date: Jun. 10, 2004

(54) Speech recognition system having an application program interface

(76) Inventors: Edward S. Miller, San Diego, CA (US); James F. Blake II, San Diego, CA (US); Kyle N. Danielson, San Diego, CA (US); Michael D. Bergman, Poway, CA (US); Keith C. Herold, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/317,837

(22) Filed: Dec. 10, 2002

(51) Int. Cl. G10L 15/00

(52) U.S. Cl. 704/231

(57) ABSTRACT

A system and method for a speech recognition system application program interface (API). The system and method additionally enable the application programmer to generate multiple grammars and voice channels, such that the audio data in any voice channel may be decoded utilizing any active grammar. The system and method enable the dynamic updating of grammars without reloading or rebooting the system. Additionally, the grammar can be implemented to include multiple grammars having multiple concepts. Still further, each concept can be implemented to include multiple phrases, and the system and method are configured to decode flexible phrase formats.

### BACKGROUND OF THE INVENTION

1. Field of the Invention

The invention relates to speech recognition technology. More particularly, the invention relates to systems and methods for a speech recognition system having an application program interface.

2. Description of the Related Technology

Speech recognition, also referred to as voice recognition, generally pertains to the technology for converting voice data to text data. Typically, in speech recognition systems the task of analyzing speech in the form of audio data and converting it to a digital representation of the speech is performed by an element of the system referred to as a speech recognition engine. Traditionally, the speech recognition engine functionality has been implemented as hardware components, or by a combination of hardware components and software modules. More recently, software modules alone perform the functionality of speech recognition engines. The use of software has become ubiquitous in the implementation of speech recognition systems in general and more particularly in speech recognition engines.

Software application programs sometimes provide a set of routines, protocols, or tools for building software applications, commonly referred to as an application program interface (API), or also sometimes referred to as an application programmer interface. A well-designed API can make it easier to develop a program by providing the building blocks a programmer uses to puts the blocks together in invoking the modules of the application program.

The API typically refers to the method prescribed by a computer operating system or by an application program by which a programmer writing an application program can make requests of the operating system or another application. The API can be contrasted with a graphical user interface (GUI) or a command interface (both of which are direct user interfaces), in that the APIs are interfaces to operating systems or programs.

Most operating environments, e.g., Windows from Microsoft Corporation being one of the most prevalent, provide an API so that programmers can write applications consistent with the operating environment. Although APIs are designed for programmers, they are ultimately good for users because they ensure that programs using a common API have similar interfaces. Common or similar APIs ultimately make it easier for users to learn new programs.

However, current speech recognition system APIs suffer from a number of deficiencies. Some are hardware dependent, making it necessary to make time consuming and expensive modification of the API for each hardware platform on which the speech recognition system is executed. Others are speaker dependent, requiring extensive training for the system to become accustomed to a particular voice and accent. Additionally, current speech recognition systems do not allow dynamic creation and modification of concepts and grammars, thereby requiring time consuming recompilation and reloading of the speech recognition system software. Some speech recognition systems do not utilize flexible phrase formats, e.g., normal, Backus Naur Form (BNF), and phonetic formats. In addition, current speech recognition systems do not allow dynamic concepts with multiple phrases. Current speech recognition systems also do not have a voice channel model or grammar set model to allow multiple simultaneous decodes for each speech port using different combinations of grammar and voice samples.

Therefore, what is needed is a system and method for a speech recognition system API that solves the above deficiencies by allowing flexible, modifiable and ease of use capabilities, including, e.g., being hardware independent, speaker independent, allowing dynamic creation and modification of concepts and grammars and concepts with multiple phrases, utilize flexible phrase formats, and have a voice channel model or grammar set model to allow multiple simultaneous decodes for each speech port using different combinations of grammar and voice samples.

### SUMMARY OF CERTAIN INVENTIVE ASPECTS

Certain embodiments of the invention include a method of adding a grammar to a speech recognition system comprising storing a first grammar in the speech recognition system, decoding a first speech audio portion with the first grammar, during operation, adding a second grammar to the speech recognition system, and decoding the first speech audio portion with the second grammar. In addition, the method further comprises removing the first grammar from the speech recognition system during operation.

In addition, some embodiments include a speech recognition system comprising a set of grammars stored externally to the speech recognition system, and an interface for loading one of the grammars into the speech recognition system while the speech recognition system is operational. Further included is the speech recognition system further comprising an application program which selectively accesses the set of grammars and interface to reconfigure the speech recognition system.

Additionally, other embodiments include a method of adding a grammar to a speech recognition system comprising, during operation, adding a first grammar having a first phrase format to the speech recognition system, decoding a first speech audio portion with the first grammar, during operation, adding a second grammar having a second phrase format to the speech recognition system, and decoding a second speech audio portion with the second grammar. Still further, included is the method wherein the phrase format is selected from the following: normal, Backus Naur Form, phonetic, or a combination of any previous of the previous formats.

In further embodiments, included is a speech recognition system comprising a set of grammars stored externally to the speech recognition system, wherein the grammars include at least two different phrase formats, and an interface for loading at least one of the grammars into the speech recognition system while the speech recognition system is operational.

Still further embodiments include a speech recognition engine comprising a collection of voice channels, a collection of grammars, and a speech port manager that manages a plurality of audio decodes, each decode resulting from assignment of a speech audio portion to a selected grammar and a selected voice channel. Further included is the speech recognition engine wherein the decode includes a confidence score. Still further included is the speech recognition engine wherein the speech audio portion is in Pulse Code Modulation format. Also included is the speech recognition engine wherein the speech audio portion is in MU-LAW format. Further included is the speech recognition engine wherein an acoustic model is selected before the decode based on a standard grammar and speaker gender.

Still further, included is a method of executing simultaneous speech audio portion decodes in a speech recognition system comprising selecting a grammar from a collection of grammars, selecting a voice channel from a collection of voice channels, decoding a speech audio portion with the selected grammar, storing the decoded audio in the selected voice channel, and repeating the above at least one time. Additionally included is the method further comprising comparing the results from each voice channel to obtain a best decoded audio portion.

In still other embodiments, included is a speech recognition system comprising a concept collection, wherein each concept is associated with multiple phrases, a decoder to decode a speech audio portion with the multiple phrases, and an interface to add a new concept and associated multiple phrases to the concept collection. Further included is the speech recognition system wherein a speech audio portion is decoded with a first grammar and a second grammar, which is added during run-time.

Included in certain embodiments is a method of adding a grammar having at least one concept and associated phrases to a speech recognition system comprising storing a first grammar having a first concept and associated phrases in the speech recognition system, decoding a first speech audio portion with the first grammar, comparing the decoded speech with each of the multiple phrases of the first concept, determining a matched phrase to the first speech audio portion, during operation, adding a second concept and associated phrases to the speech recognition system, decoding a second speech audio portion with the grammar, comparing the decoded speech with each of the multiple phrases of the second concept, and determining a matched phrase to the second speech audio portion. Also included is the method wherein the second concept is associated with the first grammar. Further included is the method wherein the second concept is associated with a second grammar. Additionally included is the method wherein the first and second concepts are the same.

### BRIEF DESCRIPTION OF THE DRAWINGS

The above and other aspects, features and advantages of the invention will be better understood by referring to the following detailed description, which should be read in conjunction with the accompanying drawings. These drawings and the associated description are provided to illustrate certain embodiments of the invention, and not to limit the scope of the invention.

FIG. 1 is a top-level diagram of certain embodiments of a speech recognition system configuration in which a speech recognition engine (SRE) API operates.

FIG. 2 is a diagram of certain embodiments of the speech recognition engine configuration illustrating the connectivity of the API with the speech ports.

FIG. 3 is a diagram of one example of a speech port configuration that can be devised utilizing the API in which multiple grammars, voice channels, concepts and phrases are illustrated.

FIG. 4 is a diagram of certain embodiments of a speech port manager that illustrate an example of the interaction between the API modules and the speech port manager internal objects.

FIG. 5 is a detailed diagram of certain embodiments of the speech port modules and data organization illustrating the interaction between the API modules and the speech port internal objects.

FIG. 6 is a detailed diagram of certain embodiments of the grammar collection modules and data organization illustrating the interaction between the API modules and the grammar collection internal objects.

FIG. 7 is a detailed diagram of certain embodiments of the voice channel collection modules and data organization illustrating the interaction between the API modules and the voice channel collection internal objects.

FIG. 8A is a diagram of the input parameters for certain embodiments of the Add Phrase module of the SRE API.

FIG. 8B is a diagram of the input parameters for certain embodiments of the Reset Grammar module of the SRE API.

FIG. 8C is a diagram of the input parameters for certain embodiments of the Load Standard Grammar module of the SRE API.

FIG. 8D is a diagram of the input parameters for certain embodiments of the Remove Concept module of the SRE API.

FIG. 8E is a diagram of the input parameters for certain embodiments of the Decode module of the SRE API.

### DETAILED DESCRIPTION OF CERTAIN EMBODIMENTS

The following detailed description of certain embodiments presents various descriptions of specific embodiments of the present invention. However, the present invention can be embodied in a multitude of different ways. In this description, reference is made to the drawings wherein like parts are designated with like numerals throughout.

Certain embodiments of the Speech Recognition Engine Application Programming Interface (SRE API) enable programmers to integrate speech recognition capabilities into their applications, without having to develop their own speech recognizer. Programmers can use the API to access the SRE, the component that performs the speech recognition. The basic steps to use certain embodiments of the SRE API include:

(1) Acquire the audio data,

(2) Specify a grammar,

(3) Start the recognition process, and

(4) Retrieve the recognition results.

Acquiring the audio data is an application-level task in certain embodiments. In other words, the programmer supplies a mechanism to record the audio data, e.g., through a microphone, telephone, or other collection or audio input device. Some embodiments of the API do not provide the method for acquiring the audio data, instead accepting the audio data once it has been collected. Thus, the API is sound-hardware independent, in that the programmer can specify multiple audio sources concurrently, so the SRE can process multiple audio recordings from different sources without reloading.

The grammar refers to a list of concepts, where a concept has a single meaning for the application. Each concept may include a list of words, phrases, or pronunciations that share the single meaning labeled by the concept. In certain embodiments, a grammar specification is completely dynamic, in the sense that the grammar, its concepts, and their words, phrases, and pronunciation can all be built while the application is running. Thus, no pre-existing grammar need be specified. The grammars can be created, deleted or modified while the application is running, so that changes to the grammar do not require reloading the application or SRE.

The programmer may begin the recognition process by specifying the audio data and grammar the SRE uses to perform recognition. In some embodiments, the SRE runs in the background, so that the application can continue other tasks while the SRE processes the audio data. Once the SRE has finished recognition, the programmer can retrieve the recognition results as a list of concepts the SRE found in the audio data. The concepts may be listed in order of appearance in the audio data. In addition, a confidence score can be given for each concept in a certain range, e.g., in the range of 0-1000. The confidence score represents how likely the SRE believes the concept actually occurred in the audio data. The programmer can use the confidence score to determine if processing is necessary to ensure a correct response. In addition to returning concepts, the programmer can also determine the specific words, phrases, or pronunciations the SRE found in the audio data.

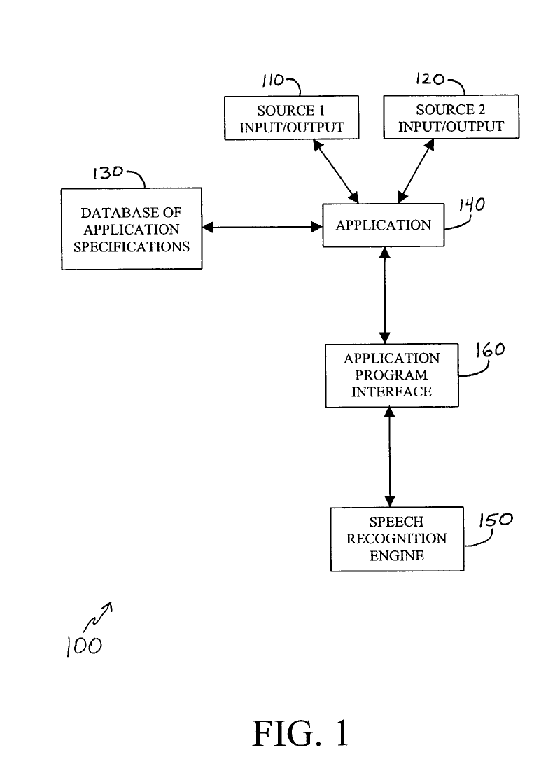

Referring now to the figures, FIG. 1 is a top-level diagram of certain embodiments of a speech recognition system 100 configuration in which a speech recognition engine (SRE) API operates. In this embodiment, the speech recognition system 100 includes an application 140, which may be one or more modules that customize the speech recognition system 100 for a particular application or use. The application 140 can be included with the speech recognition system 100 or can be separate from the speech recognition system 100 and developed and provided by the user or programmer of the speech recognition system 100.

In this embodiment, the speech recognition system 100 includes input/output audio sources, shown in FIG. 1 as a source 1 input/output 110 and a source 2 input/output. While two audio sources are shown in FIG. 1, the speech recognition system 100 may have one or a multiplicity of input/output audio sources. In addition, the audio source may be of various types, e.g., a personal computer (PC) audio source card, a public switched telephone network (PSTN), integrated services digital network (ISDN), fiber distributed data interface (FDDI), or other audio input/output source. Some embodiments of the speech recognition system 100 also include a database of application specifications 130 for storing, for example, grammar, concept, phrase format, vocabulary, and decode information. The speech recognition system 100 additionally includes a speech recognition engine (SRE) 150. The functions of the SRE include processing spoken input and translating it into a form that the system understands. The application 140 can then either interpret the result of the recognition as a command or handle the recognized audio information. The speech recognition system 100 additionally includes a speech recognition engine application program interface (API) 160, or speech port API, to enable the programmers or users to easily interact with the speech recognition engine 150.

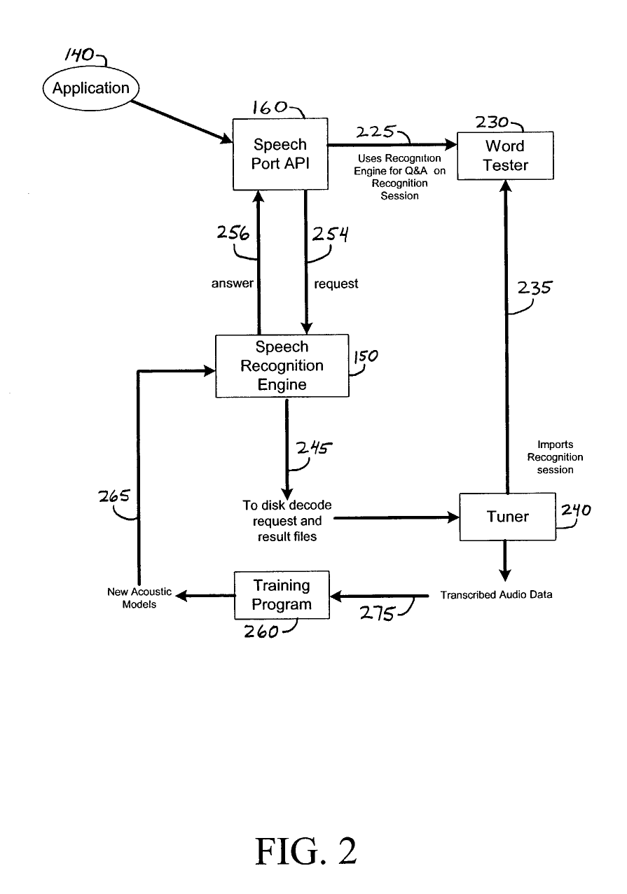

FIG. 2 is a diagram of certain embodiments of the speech recognition engine 150 configuration illustrating the connectivity of the API 160 with the speech ports. The application 140 is shown in FIG. 2 as an oval to illustrate that in this embodiment the application 140 is not integral to the SRE 150 but is developed and provided by the user of the system 100. In this embodiment, the user-developed application 140 interacts with the speech port API 160. The speech port API 160 interacts with a word tester module 230 as illustrated by an arrow 225 in FIG. 2, e.g., for invoking the speech recognition engine for questions and answers (Q&A) on the recognition session. The speech port API 160 interacts with the speech recognition engine module 150, e.g., for communicating a request to decode audio data as illustrated by an arrow 254 in FIG. 2, and for receiving an answer to the decode request as illustrated by an arrow 256.

The word tester module 230 also interacts with a tuner module 240, e.g., for receiving from the tuner module 240 information regarding a recognition session as illustrated by an arrow 235. The tuner module 240 additionally receives from the speech recognition engine 150 information regarding the disk decode request and result files as illustrated by an arrow 245. The tuner 240 interacts with a training program module 260, e.g., for communicating the transcribed audio data to the training program 260 as illustrated by an arrow 275 in FIG. 2. The training program 260 also interacts with the speech recognition engine 150, e.g., transferring the new acoustic model information to the speech recognition engine 150 as indicated by an arrow 265.

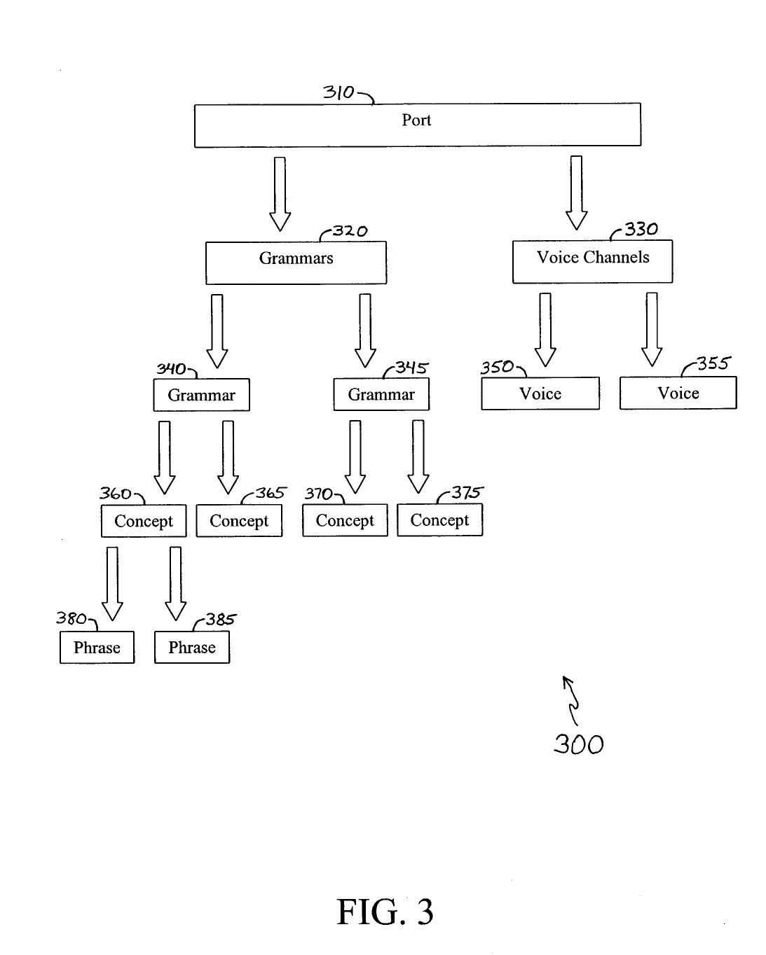

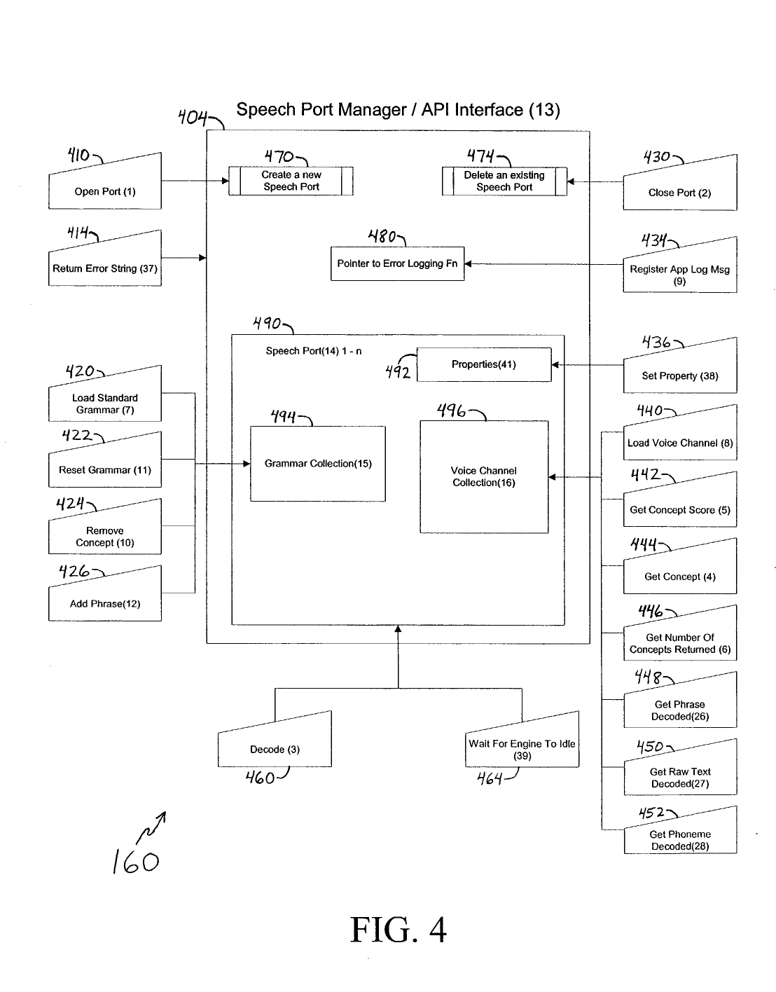

FIG. 3 is a diagram of one example of a speech port configuration 300 that can be devised utilizing the speech port API 160 in which multiple grammars, voice channels, concepts and phrases are illustrated. By utilizing the various API modules, which are described below in further detail in relation to FIGS. 4-8D, the application 140 creates a speech port having one or more grammars, one or more voice channels, one or more concepts within each grammar, and one or more phrases within each concept. FIG. 3 illustrates one example of a speech port 310 that may be created by the user application 140. Of course, in addition to the example of FIG. 3, many other examples may be created by the application 140 depending on the particular implementation of the speech port 310 that is desired for the many particular speech recognition applications that may be desired.

The speech port 310 includes grammars 320 and voice channels 330. As explained in greater detail below, the API 160 allows the application 140 to apply any grammar to any voice channel, rendering the utmost flexibility in processing the audio data and converting the audio data to the corresponding textual representation. Each speech port 310 can include one or more grammars 320 as illustrated by grammars 340, 345 in FIG. 3. Similarly, each speech port 310 can include one or more voice channels 320 as illustrated by voice channels 350, 355. In addition, for each grammar 340, 345, one or more concepts 360, 365, 370, 375 may be created and defined utilizing the speech port API 160. For each concept 360, 365, 370, 375, one or more phrases 380, 385 may be created utilizing the speech port API 160. While the example in FIG. 3 shows two instances of grammars, voice channels and phrases, and four instances of concepts, these numbers are for illustrative purposes only. The speech port API 160 allows for as few as one of these elements, and also a multiplicity of these elements, limited only by practical limitations such as storage space and processing speed and efficiency.

FIG. 4 is a diagram of certain embodiments of a speech port manager 404 that illustrate an example of the interaction between the API modules and the speech port manager 404 internal objects. Among the functions performed by the speech port manager 404 are opening and closing the speech ports and handling the communication to and from each speech port. While the embodiment illustrated in FIG. 4 shows specific module names and object relationships, one skilled in the technology would understand that alternate module names and object relationships performing substantially the same or similar function may be used in alternative embodiments, and that these alternative embodiments are within the scope of the present invention.

In the embodiments shown in FIG. 4, the API modules include an Open Port module 410 for creating a speech port object. The recognition engine 150 is initialized upon instantiation of the first speech port. Upon invoking the Open Port module 410, execution returns to the application. The Open Port module 410 in this embodiment interacts with a Create a New Speech Port module 470, which is an internal object of the speech port manager 404. The API modules in FIG. 4 additionally include a Return Error String module 414 for returning the string representation of an error code returned upon invocation of the various API modules.

Also included in the API modules is a Load Standard Grammar module 420 for designating which standard, predefined grammar to use during decode of the audio data. For example, a non-inclusive list of the possible standard grammars that may be loaded includes digits (e.g., a string of single digits), money (e.g., monetary values such as dollars and cents), numbers (e.g., numeric values like 12,000 ‘twelve thousand,’ 24.45 ‘twenty-four point forty-five,’ or 35 ‘thirty-five’), letters (e.g., A-Z), and dates (e.g., ‘Mar. 10, 2003’).

Some embodiments of the API modules include a Reset Grammar module 422 for removing all concepts from the specified grammar. The API modules also include a Remove Concept module 424 for deleting a concept and its phrases from the grammar. The API modules further include an Add Phrase module 426 for adding a phrase to a new or existing concept in one or more of the available grammars. The Load Standard Grammar module 420, Reset Grammar module 422, Remove Concept module 424 and Add Phrase module 426 in these embodiments interact with a Grammar Collection object 494 of a Speech Port object 490, which is an internal object of the Speech Port Manager 404.

The API modules shown in FIG. 4 also include a Close Port module 430 for closing and removing the specified speech port object and its link to the recognition engine 150. The Close Port module 430 interacts with a Delete an Existing Speech Port module 474, which is an internal object of the Speech Port Manager 404. A Register Application Log Message module 434 of the API is also included for registering an application level log message callback module, which handles reporting errors not directly associated with a specific speech port. The Register Application Log Message module 434 interacts with a Pointer to Error Logging Function object 480, which is a further internal object of the Speech Port Manager 404.

Further included in the embodiment of FIG. 4 is a Set Property module 436 for setting a specified property of the designated port to a specified value. For example, the Set Property module 436 enables the writing of the best result file and its corresponding request file to the hard disk. The Set Property module 436 interacts with a Properties object 492 of the Speech Port object 490, which is an internal object of the Speech Port Manager 404. A Load Voice Channel module 440 is also included in the API modules shown in FIG. 4, and loads the voice channel with the audio data Each speech port supports a plurality of voice channels, and each channel has separate storage for audio data. The API modules additionally include a Get Concept Score module 442 for retrieving a concept score stored in the result file for the voice channel.

The embodiment illustrated in FIG. 4 additionally includes a Get Concept module 444, which retrieves a concept stored in the result file for the voice channel. Further included in the API modules is a Get Number of Concepts Returned module 446 for retrieving the number of concepts stored in the result file for the voice channel. Still further included is a Get Phrase Decoded module 448 that returns the actual phrase recognized, which is the phrase as it was added using the Add Phrase module 426 discussed above. The Add Phrase module 426 enables the API to allow flexible phrase formats, e.g., normal, BNF or phonetic. The API modules additionally include a Get Raw Text Decoded module 450 for returning the actual words (as opposed to the BNF or other format) in the phrase recognized. Also included in the API modules embodiment of FIG. 4 is a Get Phoneme Decoded module 452, which returns the actual phoneme string in the phrase recognized. A phoneme generally refers to a single sound in the sound inventory of the target language.

As shown in FIG. 4, the Load Voice Channel module 440, Get Concept Score module 442, Get Concept module 444, Get Number of Concepts Returned module 446, Get Phrase Decoded module 448, Get Raw Text Decoded module 450, and Get Phoneme Decoded module 452 interact with a Voice Channel Collection object 496 of the Speech Port object 490, which is an internal object of the Speech Port Manager 404.

The embodiment illustrated in FIG. 4 additionally shows a Decode module 460, which generates the request files using the selected voice channel and grammar. The request files are sent to the recognition engine 150 and the best result file is placed in the voice channel. Also included in the API modules is a Wait for Engine to Idle module 464 for waiting for the result files to be produced from the recognition engine 150 before returning execution to the module that invoked the Wait for Engine to Idle module 464. The Decode module 460 and the Wait for Engine to Idle module 464 interact with the Speech Port object 490 of the Speech Port Manager 404.

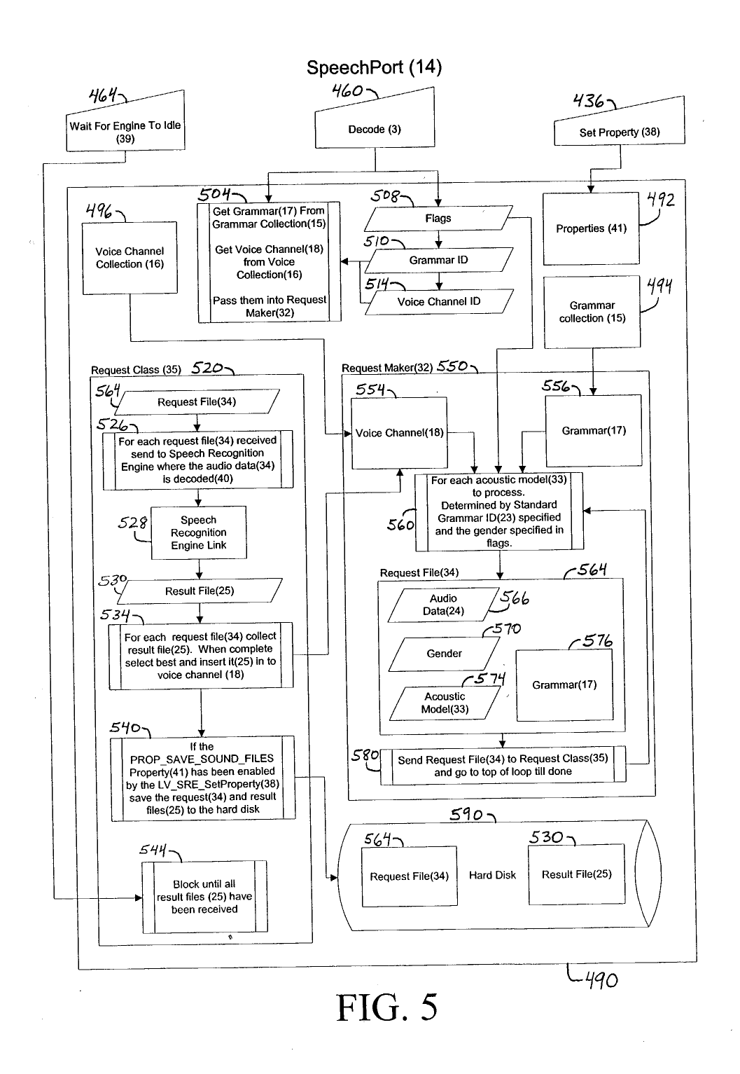

FIG. 5 is a detailed diagram of certain embodiments of the speech port modules, internal objects and data organization illustrating the interaction between the API modules and the speech port internal objects. This figure is a more detailed representation of the Speech Port 490 as shown in FIG. 4. The interactions between the API modules and the internal objects of the Speech Port 490 are described first, followed by the description of the modules, objects and data connections within certain embodiments of the Speech Port 490.

The Wait for Engine to Idle API module 464 interacts with a block 544 in the Speech Port 490 that blocks until all result files have been received. The Decode API module 460 interacts with a flags object 508 in the Speech Port 490. In some embodiments, the flags 508 include, e.g., whether the decode process should block (e.g., not run in background), whether to use the out-of-vocabulary filter, the gender of the voice data (if known), or whether the present voice is the same as the previous voice. The Decode module 460 also interacts with a block 504 for getting a grammar from the Grammar Collection 494, getting a voice channel from the Voice Channel Collection 496, and passing this information to a Request Maker object 550 (described below). The Set Property API module 436 interacts with the Properties object 492 of the Speech Port 490 as described above in relation to FIG. 4.

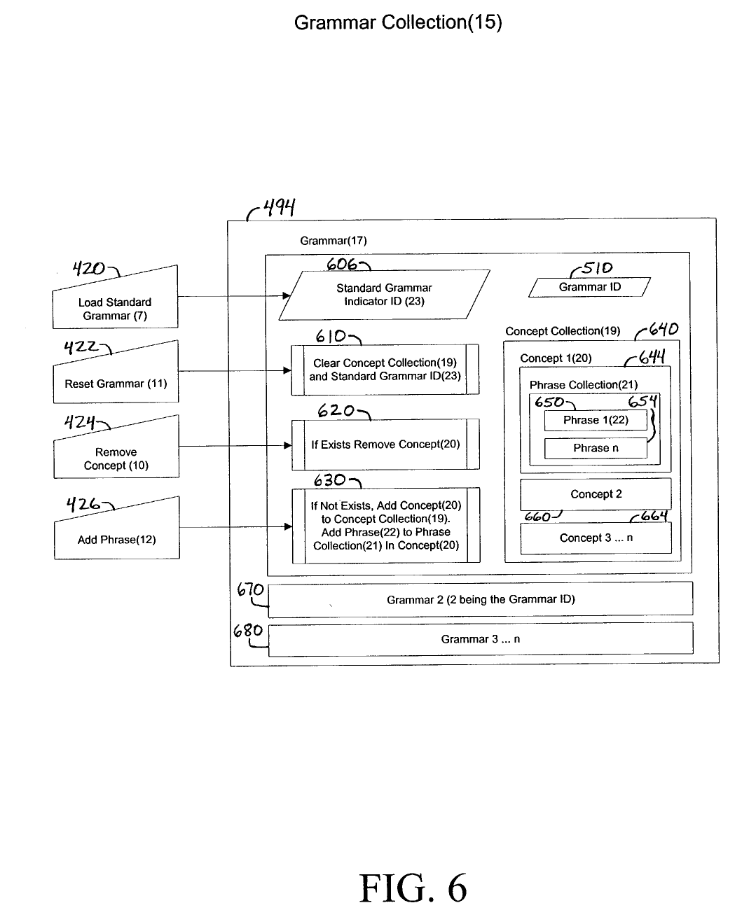

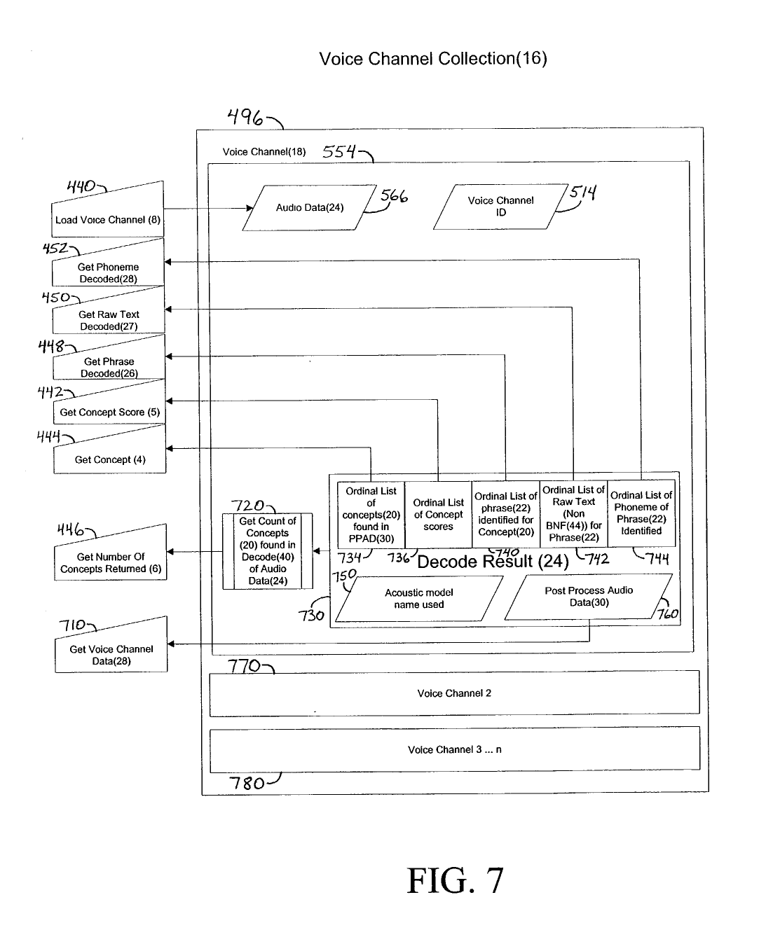

The Speech Port 490 includes the Voice Channel Collection 496 and the Grammar Collection 494, also described above in relation to FIG. 4. The Speech Port 490 produces request files 564, sends them to the speech recognition engine 150, collects result files 530 and selects the best one, e.g., the one with a highest confidence score. The result files 530 include the post-processed audio data, as well as the results of the Decode module 460 for the audio data. The block 504 receives a grammar ID 510 and a voice channel ID 514, which are indexes into the plurality of grammars and voice channel, respectively, as is described in greater detail below in relation to FIGS. 6 and 7, respectively.

The Speech Port 490 embodiment illustrated in FIG. 5 includes the Request Maker object 550. The Request Maker 550 packages the information into the request files 564 for the decoding and generation of the result files 530. The Request Maker 550 includes a voice channel module 554 and a grammar module 556, both of which are described below in relation to FIGS. 6 and 7, respectively. The Request Maker 550 additionally includes a block 560 that receives data from the voice channel 554, the grammar 556 and the flags 508. The block 560 performs a looping operation that allows the additional steps of the Request Maker 550 to be performed until an end of loop condition is detected and the loop is exited. The end of loop condition is determined by a specified standard grammar ID (see FIG. 6) and a specified gender as indicated by the flags 508.

The Request Maker 550 embodiment of FIG. 5 also manages the request file 564. The request file 564 includes audio data 566, grammar data 576, acoustic model data 574, gender data 570, and additional information flags needed for recognition, for example the information in the flags 508. In some embodiments, the acoustic model 574 is a set of Hidden Markov Models (HMM), which model the acoustic features of human language. The HMMs are triphone models, having a left phoneme, center phoneme, and right phoneme, and act to approximate the acoustic energy at each frequency for the center phoneme in the context of the left and right phonemes. The HMMs produce a probability that the current audio slice (e.g., frame) matches the particular center phoneme being examined. The Request Maker 550 additionally includes a block 580 for sending the request file 564 to a Request Class object 520 and continuing to the top of the loop at the block 560.

The Speech Port 490 embodiment shown in FIG. 5 additionally includes the Request Class object 520. The Request Class 520 includes sending the request file 564 to the speech recognition engine 150 and packaging the best results file 530 (e.g., the results file with the highest confidence score) to the voice channel 554. The Request Class 520 receives one or more request files 564, and at block 526 sends information for each request file 564 received to the speech recognition engine 150 at a speech recognition engine link block 528. At the block 528, the Request Class object 520 links to the speech recognition engine 150 for decoding the audio data for each request file 564 and producing one or more result files 530. Although the request file 564 and the result file 530 are illustrated in FIG. 5 as being internal to the Request Class object 520, in certain embodiments these files are stored external to the Request Class object 520. The request file 564 and the result file 530 are shown internal to the Request Class object 520 in FIG. 5 for purposes of illustrating that the Request Class object 530 performs operations on these files.

At a block 534 of the Request Class 520, the process collects a result file 530 for each request file 564. Also at the block 534, when the collection of the result files 530 is complete, the process selects the best result file and inserts it into the voice channel 554. The Request Class 520 further includes a block 540, which saves the request file(s) 564 and result file(s) 530 to a hard disk 590 if a save sound files property has been enabled by the Set Property API module 436 and stored in the Properties object 492. Although the embodiment of FIG. 5 illustrates storage to a hard disk 590, in other embodiments storage of the request file(s) 564 and result file(s) 530 is to any of a number of storage devices, e.g., memory, tape storage, floppy disk, and optical storage devices. The Request Class 520 additionally includes a block 544, at which the process blocks (waits or pauses) until all the result files 530 have been received.

FIG. 6 is a detailed diagram of certain embodiments of the Grammar Collection 494 modules and data organization illustrating the interaction between the API modules and the grammar collection internal objects. This figure is a more detailed representation of the Grammar Collection 494 as shown in FIG. 4. The Grammar Collection 494 holds the grammars instantiated for the particular Speech Port 490. The grammars are templates that describe a set of strings, such as strings of spoken words, and speech grammar refers to a template that specifies a set of valid utterances. The interactions between the API modules and the internal objects of the Grammar Collection 494 are described below, followed by the description of the modules, objects and data connections within certain embodiments of the Grammar Collection object 494.

The Load Standard Grammar API module 420 interacts with a Standard Grammar Indicator ID 606 in the Grammar Collection 494. The Standard Grammar Indicator ID 606 value identifies which of the several predefined grammars has been identified as the selected standard grammar. The Standard Grammar Indicator ID 606 alternatively indicates which predefined grammar the current decode processing is to use with the current voice channel. The Reset Grammar API module 422 interacts with a block 610 in the Grammar Collection 494. The process at the block 610 clears a Concept Collection 640 (described below in relation to the present figure) and clears the Standard Grammar Indicator ID 606.

The Remove Concept API module 424 interacts with a block 620, which determines if the concept requested for removal exists, and removes the concept if it does exist. The Add Phrase API module 426 interacts with a block 630 of the Grammar Collection 494. At the block 630, the process determines if a specified concept for the phrase exists, and adds the concept to the Concept Collection 640 if the concept does not exist. The block 630 additionally adds the specified phrase to a Phrase Collection 646 in a specified concept 644, 660, 664.

The Grammar Collection 494 embodiment illustrated in FIG. 6 includes the grammar ID 510 as shown in FIG. 5. The Grammar Collection 494 also includes the Concept Collection 640, which further includes one or more concepts 644, 660, 664, shown in FIG. 6 for purposes of illustration only as Concept 1 644, Concept 2 660, and Concept 3 . . . n 664. The actual number of concepts instantiated in a particular Concept Collection 640 is likely to vary from application to application, and can be from one to a multitude of concepts. The Concept Collection 640 includes the concepts associated with a particular grammar.

Each of the concepts, e.g., Concept 1 644 as shown in FIG. 6, includes a Phrase Collection 646, which includes one or more individual phrases, as shown by Phrase 1 650 and Phrase n 654. One or a multitude of phrases can be included in each Phrase Collection 646. Generally speaking, a concept is a set of phrases organized under a single idea (concept). For example, ‘yes’, ‘yeah’, and ‘of course’ are all occurrences of the idea ‘affirmative’. The concept in this example is ‘affirmative’, whose idea can be conveyed by using any of the phrases ‘yes’, ‘yeah’, or ‘of course.’ In this context, the Phrase Collection 646 is the collection of phrases that define the particular concept. In other words, the Phrase Collection 646 is the set of phrases (Phrase 1 650 to Phrase n 654) that share the idea encapsulated by the concept. In this way, the API enables the concept model to “umbrella” multiple phrases under a single concept or idea.

Phrases can be thought of as the segments of speech that the recognizer, or SRE, attempts to identify in the audio data. A phrase is a candidate the recognizer tries to identify in an instance of audio data. For example, a phrase can consist of a word, a word block, a BNF construct, or a phoneme block. Each phrase generally conveys a single idea. A word is a recognizable written word in the target language. A word block is an ordered set of words.

The Grammar Collection 494 shown in FIG. 6 may also include more grammars in addition to the grammar described above for the grammar 556. One or a multitude of grammars can be instantiated as required by the particular application utilizing the Speech Port API 160. For illustrative purposes, FIG. 6 shows a grammar 2 670 and a grammar 3 . . . n 680. However, other embodiments may have one or a multitude of grammars instantiated depending on the requirements of the particular application.

Using the API modules described above, the grammars can be dynamically changed and entered into the speech recognition system without reloading or rebooting the system. The database storing the grammar data can be unique to each application user depending on their individual requirements. For example, a programmer can define a concept for recognizing each of the fifty states. In this example, the concept “Washington D.C.” could have multiple phrases defined, such as “Washington D.C.” or “District of Columbia.” If the user says “Florida,” the speech recognition system may interpret it to be “Oregon.” At this point, the programmer could use the API to define the system to ask if the user said “Oregon,” to which the user would respond with “no.” The programmer can configure the system to dynamically remove “Oregon” from the grammar, then decode the same audio data again using the updated grammar, without reloading or rebooting the system. The API further enables the dynamic removal or addition of multiple concepts, phrases or grammars in this way.

FIG. 7 is a detailed diagram of certain embodiments of the Voice Channel Collection 496 modules and data organization illustrating the interaction between the API modules and the voice channel collection internal objects. This figure is a more detailed representation of the Voice Channel Collection 496 as shown in FIG. 4. The Voice Channel Collection 496 holds the voice channels implemented for the particular Speech Port 490. The interactions between the API modules and the internal objects of the Voice Channel Collection 496 are described below, followed by the description of the modules, objects and data connections within certain embodiments of the Voice Channel Collection 496.

The Load Voice Channel API module 440 interacts with the audio data object 566 as described above in relation to FIG. 5. The Get Phoneme Decoded API module 452 interacts with a block 744 in a Decode Result module 730. The block 744 includes an ordinal list of phonemes of the phrase identified. The Decode Result module 730 is described in greater detail below in relation to the present figure.

The Get Raw Text Decoded API module 450 interacts with a block 742 of the Decode Result module 730. The block 742 includes an ordinal list of raw text (non BNF) for the phrase. The Get Phrase Decoded API module 448 interacts with a block 740 of the Decode Result module 730. The block 740 includes an ordinal list of the phrase identified for the concept. The Get Concept Score API module 442 interacts with a block 736 of the Decode Result module 730. The block 736 includes an ordinal list of concept scores for the decode process. The Get Concept API module 444 interacts with a block 734 of the Decode Result module 730. The block 734 includes an ordinal list of concepts found in a post processed audio data (PPAD) object 760. In some embodiments, the SRE converts application audio data to Pulse Code Modulation (PCM) 16 Khz, normalizes the volume level and removes long silence portions. This audio data is referred to as the post processed audio data 760 and is used in performing the actual speech recognition. The Get Number of Concepts Returned API module 446 interacts with a block 720 of the Voice Channel Collection 496. The block 720 gets a count of the concepts found in the decode process of the audio data 566. The Get Voice Channel Data API module 710 interacts with the post process audio data object 760 of the Decode Result module 730. The Get Voice Channel Data module 710 retrieves the post processed audio data 760 from the result file 530 in the voice channel 554. The post process audio data 760 is returned by the decode process, which modifies the audio data 566 in various ways and returns the post process audio data 760.

The Voice Channel Collection 496 shown in the embodiment of FIG. 7 includes the voice channel ID 514 and the audio data object 566 (see FIG. 5). The audio data 566 is the digitized representation of the speaker's utterance. The speech recognizer accepts MU-LAW sampled at 8 kilohertz (KHz), PCM sampled at 8 KHz, and PCM sampled at 16 KHz. MU-LAW AND PCM are standard sound formats in widespread use in the audio data file industry. PCM is a sampling technique for digitizing analog signals, especially audio signals. Typically, PCM samples the signal 8000 times a second, and each sample is represented by 8 bits of data for a total of 64 K bits. There are presently two standards for coding the sample level; the MU-LAW standard is used in North America and Japan while the A-LAW standard is used in most other countries.

The Voice Channel Collection 496 additionally includes the Decode Result module 730. In addition to the objects of the Decode Result module 730 described above in relation to the present figure, the Decode Result module 730 further includes an acoustic model name used object 750.

The ordinal list blocks 734, 736, 740, 742, 744 of the Decode Result module 730 are now described in greater detail. In some embodiments, the speech recognition engine 150 is an order independent recognizer. The concepts that are present in the grammar are decoded in the order spoken in the audio data. The ordinal list contains the concepts identified in the order found. The concept score is the confidence of the concept being accurately identified by the decode process. The phrase is the specific phrase the decode process selected, keeping in mind that a concept can have multiple phrases. When BNF is used the raw text is the actual version that was selected. Following is an example: a BNF phrase=‘Yes [please].’ The audio data is a person speaking ‘Yes’. The phrase is ‘Yes [please].’ The corresponding raw text is ‘Yes.’

A BNF construct is a phrase in an adapted Backus Naur Format. Generally speaking, BNF refers to a text language used to specify the grammars of programming languages. The BNF uses only terminal symbols, and allows for selections between options using the ‘|’ symbol and optional elements (e.g., elements which may or may not appear, but are neither required nor prohibited) using ‘(‘ and ’)’ to surround the optional element. The elements can be a word, word block, phoneme, or phoneme block. In addition, the BNF construct allows a following ‘:’ plus word block, to designate what the preceding elements label.

Phoneme blocks are ordered sets of phonemes, corresponding to a pronunciation of a word or word block, as described below.

{}—denote the Phoneme Block

{Y AE}

:—marks a label for the phoneme block. This label replaces the phoneme block in the raw text found in the result file.

{Y AE: yeah}

To choose between forms of the concept ‘yes’: ‘yes’ (a word), ‘of course’ (a word block), ‘UH’ (a phoneme), ‘Y AE’ (a phoneme block):

{yes|(of)course|{Y AH P: Yup}|{Y AE:yeah}} chooses between each of the four forms, allowing either ‘of course’ or ‘course’ for the second form.

The phoneme is the actual phoneme set that was picked. A word can actually have multiple phoneme variations to handle different dialects.

A further example is when the grammar (not detailed) contains concepts and phrases representing colors and the audio data contains a person speaking the words: violet midnight blue red. The ordinal list from the Decode Result module 730 in this example may be as follows:

| Concept | Score | Phrase | Raw Text | Phoneme |
|---|---|---|---|---|
| Purple | 700 | Violet | Violet | V AY AH L IH T |
| Blue | 450 | [(midnight \| | midnight blue | M IH D N AY T & |
| | | Royal)] | | B L UW |
| Red | 625 | Red | Red | R EH D |

The Voice Channel Collection 496 embodiment shown in FIG. 7 also includes more voice channels in addition to the voice channel described above for the voice channel 554. The voice channel 554 contains the audio data 566 collected from the speaker and the most recent result file 530. One or a multitude of voice channels can be instantiated as required by the particular application utilizing the speech port API 160. For illustrative purposes, FIG. 7 shows a voice channel 2 770 and a voice channel 3 . . . n 780. However, other embodiments may have one or a multitude of voice channels implemented depending on the requirements of the particular application.

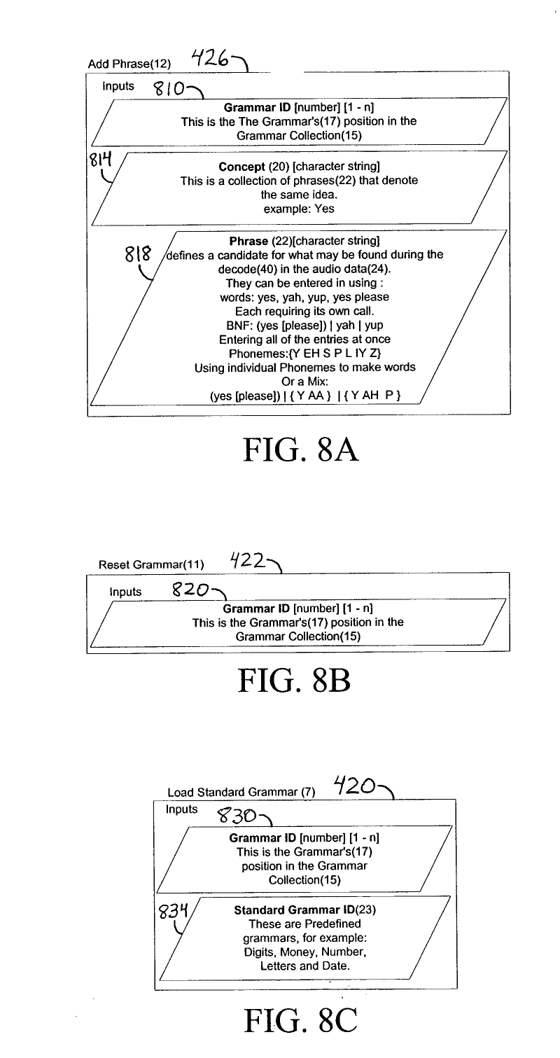

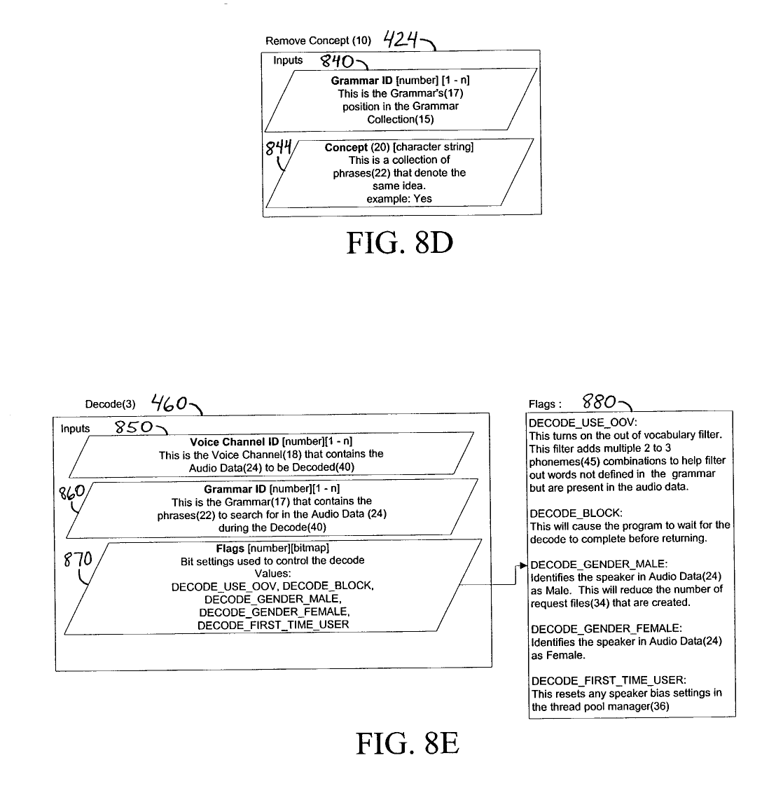

FIG. 8A is a diagram of the input parameters for certain embodiments of the Add Phrase module 426 of the SRE API 160. As shown in FIG. 8A, the Add Phrase module 426 receives as input a grammar ID parameter 810, a concept parameter 814, and a phrase parameter 818. The grammar ID parameter 810 specifies the grammar's position in the Grammar Collection 494, e.g., an index into the list of grammars instantiated. The concept parameter 814 is a character string of a collection of phrases denoting the same or a related idea. The phrase parameter 818 is a character string defining a candidate for what may be found in the audio data during the decode process. In some embodiments, the parameters are entered as words, BNF, phonemes, or a combination of these.

FIG. 8B is a diagram of the input parameters for certain embodiments of the Reset Grammar module 422 of the SRE API 160. As shown in FIG. 8B, the Reset Grammar module 422 receives as input a grammar ID parameter 820. The grammar ID parameter 820 specifies the grammar's position in the Grammar Collection 494, e.g., an index into the list of grammars instantiated.

FIG. 8C is a diagram of the input parameters for certain embodiments of the Load Standard Grammar module 420 of the SRE API 160. As shown in FIG. 8C, the Load Standard Grammar module 420 receives as input a grammar ID parameter 830 and a standard grammar ID parameter 834. The grammar ID parameter 830 specifies the grammar's position in the Grammar Collection 494, e.g., an index into the list of grammars instantiated. The standard grammar ID parameter 834 specifies the standard grammar selected, for example digits, money, number, letters or dates standard grammars.

FIG. 8D is a diagram of the input parameters for certain embodiments of the Remove Concept module 424 of the SRE API 160. As shown in FIG. 8D, the Remove Concept module 424 receives as input a grammar ID parameter 840 and a concept parameter 844. The grammar ID parameter 840 specifies the grammar's position in the Grammar Collection 494, e.g., an index into the list of grammars instantiated. The concept parameter 844 is a character string of a collection of phrases denoting the same or a related idea.

FIG. 8E is a diagram of the input parameters for certain embodiments of the Decode module 460 of the SRE API 160. As shown in FIG. 8E, the Decode module 460 receives as input a voice channel ID parameter 850, a grammar ID parameter 860, and a flags parameter 870. The voice channel ID parameter 850 specifies the voice channel position in the Voice Channel Collection 496 that contains the audio data to be decoded, e.g., an index into the list of voice channels implemented. The grammar ID parameter 860 specifies the grammar's position in the Grammar Collection 494 that contains the phrases to search for in the audio data during the decode process, e.g., an index into the list of grammars instantiated. The flags parameter 870 specifies the bit settings indicating the flag values to use to control various alternatives or options in the decode process. In some embodiments, the flags include values indicating to decode using the out of vocabulary filter, wait for completion before returning from the decode process, decode for a male speaker, decode for a female speaker, decode for a new speaker without utilizing any bias settings. The flag values in some embodiments of the flags parameter 870 are detailed in block 880 in FIG. 8E. The Decode module 460 enables the application programmer to perform the decode process on any combination of the multiple different voice channels (containing audio data) with the multiple different defined grammars. In other words, the grammars and voice channels can be mixed and matched in any combination in the decoding process.

Appendix A illustrates several examples to assist an application programmer in performing various operations, e.g., initializing, using and shutting down, on a speech recognition system using certain above-described embodiments of the SRE API. Of course, there are many other ways of utilizing the SRE API in addition to those shown by the examples in Appendix A.

While the above detailed description has shown, described, and pointed out novel features of the invention as applied to various embodiments, it will be understood that various omissions, substitutions, and changes in the form and details of the device or process illustrated may be made by those skilled in the art without departing from the intent of the invention.

[image]

[image]

[image]

[image]

[image]

[image]

[image]

[image]

[image]

[image]

[image]

[image]

[image]

What is claimed is:

1. A method of adding a grammar to a speech recognition system, the method comprising:
storing a first grammar in the speech recognition system;
decoding a first speech audio portion with the first grammar;
during operation, adding a second grammar to the speech recognition system; and
decoding the first speech audio portion with the second grammar.

2. The method of claim 1, further comprising removing the first grammar from the speech recognition system during operation.

3. A speech recognition system, comprising:
a set of grammars stored externally to the speech recognition system; and
an interface for loading one of the grammars into the speech recognition system while the speech recognition system is operational.

4. The speech recognition system of claim 3, further comprising an application program which selectively accesses the set of grammars and interface to reconfigure the speech recognition system.

5. A method of adding a grammar to a speech recognition system, the method comprising:
during operation, adding a first grammar having a first phrase format to the speech recognition system;
decoding a first speech audio portion with the first grammar;
during operation, adding a second grammar having a second phrase format to the speech recognition system; and
decoding a second speech audio portion with the second grammar.

6. The method of claim 5, wherein the phrase format is selected from the following: normal, Backus Naur Form, phonetic, or a combination of any of the previous formats.

7. A speech recognition system, comprising:
a set of grammars stored externally to the speech recognition system, wherein the grammars include at least two different phrase formats; and
an interface for loading at least one of the grammars into the speech recognition system while the speech recognition system is operational.

8. A speech recognition engine, comprising:
a collection of voice channels;
a collection of grammars; and
a speech port manager that manages a plurality of audio decodes, each decode resulting from assignment of a speech audio portion to a selected grammar and a selected voice channel.

9. The speech recognition engine of claim 8, wherein the decode includes a confidence score.

10. The speech recognition engine of claim 8, wherein the speech audio portion is in Pulse Code Modulation format.

11. The speech recognition engine of claim 8, wherein the speech audio portion is in MU-LAW format.

12. The speech recognition engine of claim 8, wherein an acoustic model is selected before the decode based on a standard grammar and speaker gender.

13. A method of executing simultaneous speech audio portion decodes in a speech recognition system, the method comprising:
selecting a grammar from a collection of grammars;
selecting a voice channel from a collection of voice channels;
decoding a speech audio portion with the selected grammar;
storing the decoded audio in the selected voice channel; and
repeating the above at least one time.

14. The method of claim 13, further comprising comparing the results from each voice channel to obtain a best decoded audio portion.

15. A speech recognition system, comprising:
a concept collection, wherein each concept is associated with multiple phrases;
a decoder to decode a speech audio portion with the multiple phrases; and
an interface to add a new concept and associated multiple phrases to the concept collection.

16. The speech recognition system of claim 15, wherein a speech audio portion is decoded with a first grammar and a second grammar, which is added during run-time.

17. A method of adding a grammar having at least one concept and associated phrases to a speech recognition system, the method comprising:
storing a first grammar having a first concept and associated phrases in the speech recognition system;
decoding a first speech audio portion with the first grammar;
comparing the decoded speech with each of the multiple phrases of the first concept;
determining a matched phrase to the first speech audio portion;
during operation, adding a second concept and associated phrases to the speech recognition system;
decoding a second speech audio portion with the grammar;
comparing the decoded speech with each of the multiple phrases of the second concept; and
determining a matched phrase to the second speech audio portion.

18. The method of claim 17, wherein the second concept is associated with the first grammar.

19. The method of claim 17, wherein the second concept is associated with a second grammar.

20. The method of claim 17, wherein the first and second concepts are the same.
